(19) United States
(12) Patent Application Publication
(10) Pub. No.: US 2019/0205272 A1
(43) Pub. Date: Jul. 4, 2019

(54) COMPENSATION FOR HOLD-OVER ERRORS IN DISTRIBUTED CLOCK SYNCHRONIZATION

(71) Applicant: Intel Corporation, Santa Clara, CA (US)

(72) Inventors: Zoltan FODOR, Swindon (GB); Jakub FORNAL, Gdynia (PL)

(21) Appl. No.: 16/299,905

(22) Filed: Mar. 12, 2019

(51) Int. Cl. G06F 13/16; G06F 16/903; G06F 13/38; G06F 13/12

(52) U.S. Cl. CPC G06F 13/1689; G06F 16/903; G06F 2213/0026; G06F 13/126; G06F 13/385

(57) ABSTRACT

Examples include a method of compensating for hold-over errors in a distributed clock synchronization system. When a first computing platform has a synchronized connection with a second computing platform, a clock sync component obtains a first temperature of a network input/output (I/O) device of the first computing platform and a frequency adjustment value of a clock of the network I/O device and stores the temperature and the frequency adjustment value in an entry in a clock synchronization database. When the first computing platform does not have a synchronized connection with the second computing platform (e.g., hold-over mode), the clock sync component obtains a second temperature of the network I/O device, searches the clock synchronization database for the entry where the first temperature is closest to the second temperature, and when the entry is found, obtains the frequency adjustment value and adjusts the clock of the network I/O device using the frequency adjustment value.

### BACKGROUND

A distributed clock synchronization mechanism uses a remote node acting as a master clock to synchronize one or more slave clocks of other nodes. Without synchronization the nodes use their local clock source (e.g., an oscillator). Clock synchronization is needed as there is a natural difference (e.g., an initial offset) in the frequency of the local clock sources. A distributed clock synchronization mechanism operates by sending messages between the master and slave clocks in order to adjust the frequency of the slave clocks. However, if for some reason, such as network interruption, this message sequence cannot be communicated, the slave node goes into a hold-over mode in which the slave node maintains time based on the slave node's local clock source and any previously archived synchronization information. External disturbances, such as temperature and other natural forces, can influence the frequency of the slave clocks. Therefore, slave clocks can deviate in hold-over mode from their synchronized clock states over time. The cumulative errors can grow to unacceptable levels forcing a distributed computing system to stop operating and causing application specific problems.

The initial offset of the slave clocks is not a significant problem as the initial offset can be reduced to a small level by typical distributed clock synchronization solutions. However, temperature changes of the oscillator, which is typically a quartz crystal having a one to two parts per million (ppm)/° C. temperature error, can negatively affect clock synchronizations.

### BRIEF DESCRIPTION OF THE DRAWINGS

FIG. 1 illustrates an example computing system.

FIG. 2 illustrates an example network I/O device.

FIG. 3 illustrates an example software stack for network I/O processing.

FIG. 4 illustrates an example arrangement of a master clock and a slave clock.

FIG. 5 illustrates an example flow diagram of a process to correct hold over errors according to an embodiment.

FIG. 6 illustrates an example of a storage medium.

FIG. 7 illustrates another example computing platform.

### DETAILED DESCRIPTION

Embodiments of the present invention disclose a method of compensating for hold-over errors occurring in a distributed clock synchronization system. When a network connection is interrupted between two distributed computing systems, this hold-over scenario results in deviations between the master clock in one computing system and the slave clock in another computing system. Embodiments of the present invention adjust the slave clocks to stay synchronized with the master clock, thereby overcoming the hold-over errors.

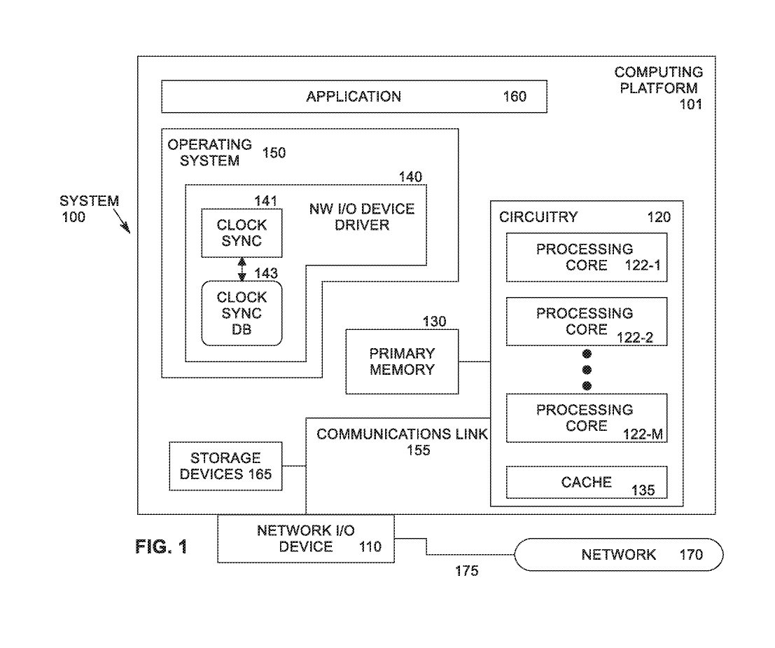

FIG. 1 illustrates an example computing system 100. Computing system 100 is representative of a first computing system having a master clock, and a second computing system having a slave clock. As shown in FIG. 1, computing system 100 includes a computing platform 101 coupled to a network 170 (which may be the Internet, for example). In some examples, as shown in FIG. 1, computing platform 101 is coupled to network 170 via network communication channel 175 and through network I/O device 110 (e.g., a network interface controller (NIC)) having one or more ports connected or coupled to network communication channel 175. In an embodiment, network communication channel 175 includes a PHY device (now shown). In an embodiment, network I/O device 110 is an Ethernet NIC. Network I/O device 110 transmits data packets from computing platform 101 over network 170 to other destinations and receives data packets from other destinations for forwarding to computing platform 101. In some situations, packets include information to synchronize the clock (not shown) of computing platform 101 with another computing platform.

According to some examples, computing platform 101, as shown in FIG. 1, includes circuitry 120, primary memory 130, network (NW) I/O device driver 140, operating system (OS) 150, at least one application 160, and one or more storage devices 165. In one embodiment, OS 150 is Linux™. In another embodiment, OS 150 is Windows® Server. Network I/O device driver 140 operates to initialize and manage I/O requests performed by network I/O device 110.

In an embodiment, network I/O device driver 140 includes a clock synchronization (sync) component 141 to adjust a clock of the computing platform (when computing platform is operating as a slave) to overcome hold-over errors. In an embodiment, network I/O device driver 140 includes clock sync database (DB) 143 to store temperature and associated clock frequency data.

In an embodiment, packets and/or packet metadata transmitted to network I/O device 110 and/or received from network I/O device 110 are stored in one or more of primary memory 130 and/or storage devices 165. In an embodiment, clock sync DB 143 is stored in one or more of primary memory 130 and/or storage devices 165. In at least one embodiment, storage devices 165 may be one or more of hard disk drives (HDDs) and/or solid-state drives (SSDs). In an embodiment, storage devices 165 may be non-volatile memories (NVMs). In some examples, as shown in FIG. 1, circuitry 120 may communicatively couple to network I/O device 110 via communications link 155. In one embodiment, communications link 155 is a peripheral component interface express (PCIe) bus conforming to version 3.0 or other versions of the PCIe standard published by the PCI Special Interest Group (PCI-SIG). In some examples, operating system 150, NW I/O device driver 140, and application 160 are implemented, at least in part, via cooperation between one or more memory devices included in primary memory 130 (e.g., volatile or non-volatile memory devices), storage devices 165, and elements of circuitry 120 such as processing cores 122-1 to 122-m, where “m” is any positive whole integer greater than 2. In an embodiment, OS 150, NW I/O device driver 140, and application 160 are executed by one or more processing cores 122-1 to 122-m.

In some examples, computing platform 101, includes but is not limited to a server, a server array or server farm, a web server, a network server, an Internet server, a work station, a mini-computer, a main frame computer, a supercomputer, a network appliance, a web appliance, a distributed computing system, multiprocessor systems, processor-based systems, a laptop computer, a tablet computer, a smartphone, or a combination thereof. In one example, computing platform 101 is a disaggregated server. A disaggregated server is a server that breaks up components and resources into subsystems. Disaggregated servers can be adapted to changing storage or compute loads as needed without replacing or disrupting an entire server for an extended period of time. A server could, for example, be broken into modular compute, I/O, power and storage modules that can be shared among other nearby servers. In an embodiment, computing platform 101 is an infotainment system resident in a vehicle (e.g., an automobile, a truck, a motorcycle, etc.), a ship, an aircraft, or a spacecraft.

Circuitry 120 having processing cores 122-1 to 122-m may include various commercially available processors, including without limitation Intel® Atom®, Celeron®, Core (2) Duo®, Core i3, Core i5, Core i7, Itanium®, Pentium®, Xeon® or Xeon Phi® processors, ARM processors, and similar processors. Circuitry 120 may include at least one cache 135 to store data.

According to some examples, primary memory 130 may be composed of one or more memory devices or dies which may include various types of volatile and/or non-volatile memory. Volatile types of memory may include, but are not limited to, dynamic random-access memory (DRAM), static random-access memory (SRAM), thyristor RAM (TRAM) or zero-capacitor RAM (ZRAM). Non-volatile types of memory may include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAIVI), magneto-resistive random-access memory (MRAM) that incorporates memristor technology, spin transfer torque MRAM (STT-MRAM), or a combination of any of the above. In another embodiment, primary memory 130 may include one or more hard disk drives within and/or accessible by computing platform 101.

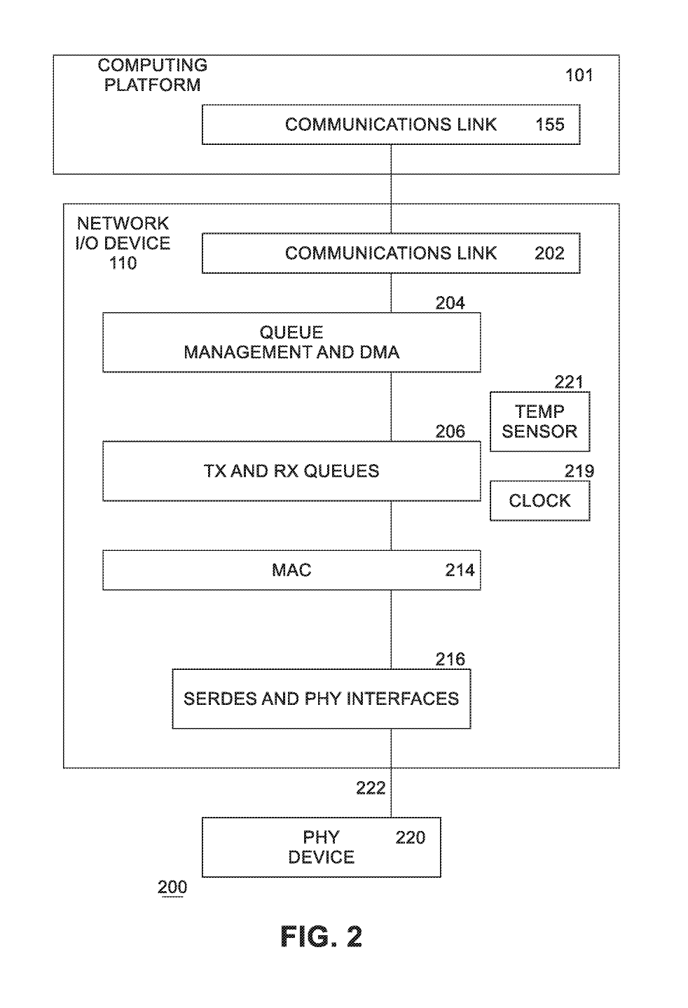

FIG. 2 illustrates an example network I/O device 110. On the host side, network I/O device 110 connects to computing platform 101 by communications link 155 (e.g., a PCIe bus). On the network side, network I/O device 110 connects to PHY device 220 which forms at least a part of network communications channel 175 shown in FIG. 1. PHY device 220 is any circuitry to implement physical layer functions for networking. A PHY device connects a link layer device (i.e., network I/O device 110) to a physical medium such as an optical fiber or a copper cable. A PHY device typically includes both physical coding sublayer (PCS) and physical medium dependent (PMD) layer functionality. A PHY chip (also known as a PHYceiver and embodied in PHY device 220) is commonly found in Ethernet devices. One purpose of PHY device 220 is to provide analog signal physical access to the link. PHY device 220 is used in conjunction with a Media Independent Interface (MII) 222 communications link or interfaced to a microcontroller that takes care of the higher layer functions. When PHY device 220 is an Ethernet PHY chip, PHY device implements the hardware send and receive functions of Ethernet frames. PHY device 220 interfaces between the analog domain of Ethernet's line modulation and the digital domain of link-layer packet signaling.

MII 222 is defined as a standard interface to connect a Gigabit Ethernet (MAC) block to a PHY chip. The MII is defined by IEEE 802.3 and connects different types of PHYs to MACs. Being media independent means that different types of PHY devices for connecting to different media (i.e., twisted pair, fiber optic, etc.) can be used without redesigning or replacing the MAC hardware (i.e., network I/O device 110). Thus, any MAC may be used with any PHY, independent of the network signal transmission media. The MIL can be used to connect a MAC to an external PHY using a pluggable connector, or directly to an internal PHY chip which is on the same printed circuit board (PCB).

Network I/O device 110 includes communications link 202 circuitry (e.g., PCIe bus circuitry) to communicate with communications link 155 of computing platform 101. Network I/O device 110 includes serializer/de-serializer (SerDes) and PHY interfaces circuitry 216 to communication with PHY device 220 over interface 222 (e.g., SGMII in an embodiment). Queue management and direct memory access (DMA) circuitry 204 is included to manage the traffic flow of transmitted and received packets. Transmit (Tx) and receive (Rx) queues 206 are included to store incoming and outgoing packets and associated metadata. In an embodiment, at least one queue is used to store AVB packets. In other embodiments, any number of queues may be used. MAC circuitry 214 is the processing unit within network I/O device 110 to process transmitting and/or receiving packets.

Network I/O device 110 includes at least one clock 219. When the network I/O device is coupled to a computing platform that is operating as a master, clock 219 is a master clock. When network I/O device is coupled to a computing platform that is operating as a slave, clock 219 is a slave clock. In one embodiment, network I/O device 110 includes internal temperature (temp) sensor 221 to sense the temperature of the network I/O device 110. In another embodiment, temp sensor 221 is external to network I/O device 110. In either case, network I/O device driver 140 is capable of reading temp sensor 221 to obtain the current temperature of the network I/O device, including clock 219.

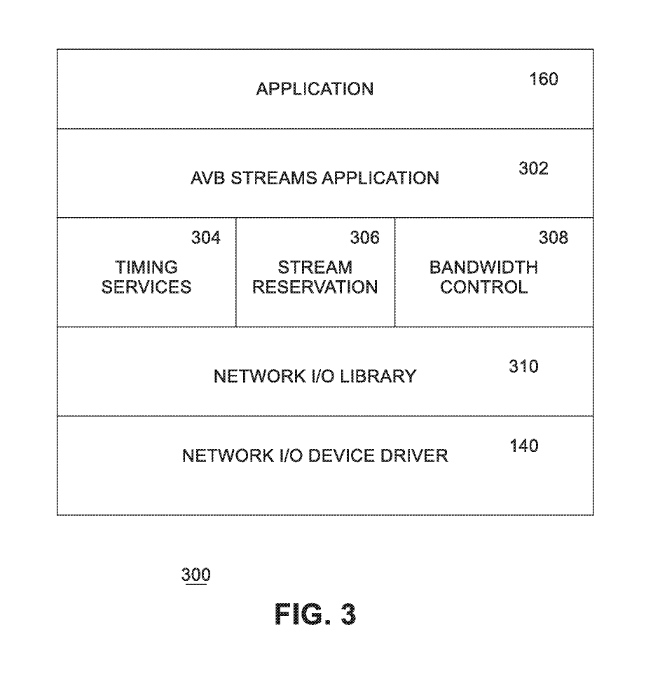

FIG. 3 illustrates an example software stack 300 for network I/O processing. Application 160 performs any processing desired by a user of the computing platform. In an embodiment, application is an infotainment cockpit program to control and/or manage the operation of one or more functions of a vehicle (e.g., an automobile, a truck, a motorcycle, etc.), a ship, an aircraft, or a spacecraft. In an embodiment, software stack 300 includes an AVB streams application 302 to manage transmitting and receiving of AVB data streams in computing platform 101. In an embodiment, AVB streams application 302 is part of application 160. In another embodiment, AVB streams application 302 is part of OS 150.

Software stack 300 includes at least three components to assist in handling AVB streams. Timing services component 304 synchronizes clocks (such as clock 219) used in computing platform 101 and network 170. In an embodiment, timing services component 304 implements one or more of a Precision Time Protocol (PTP) entitled “Standard for a Precision Clock Synchronization Protocol for Networked Measurement and Control Systems” published in 2008 as IEEE 1588-2008 and IEEE 802.1AS-2011, entitled “Standard for Local and Metropolitan Area Networks—Timing and Synchronization for Time-Sensitive Applications in Bridged Local Area Networks” (part of the IEEE (AVB) group of standards), further extended by the IEEE 802.1 Time-Sensitive Networking (TSN) Task Group). IEEE 802.1AS-2011 specifies a profile for use of IEEE 1588-2008 for time synchronization over a virtual bridged local area network. In particular, 802.1AS-2011 defines how IEEE 802.3 (Ethernet), IEEE802.11 (WiFi), and Multimedia over Coax Alliance (MoCA) implementations can all be parts of the same PTP timing domain. In other embodiments, other timing and synchronization protocols may be used.

Stream reservation component 306 implements a stream reservation protocol for an Ethernet implementation. In an embodiment, stream reservation component 306 implements IEEE 802.1Q-2011, entitled “Standard for Local and Metropolitan Area Networks—Virtual Bridged Local Area Networks—Amendment: 9: Stream Reservation Protocol (SRP)”. SRP defines the concept of a streams at layer 2 of the OSI model. Stream reservation component 306 provides a mechanism for end-to-end management of the resources of streams to guarantee Quality of Service (QoS).

Bandwidth control component 308 controls time-sensitive, loss-sensitive real-time AV transmissions. In an embodiment, bandwidth control component 308 implements IEEE 802.1 QAV, entitled “IEEE Standard for Local and Metropolitan Area Networks—Virtual Bridged Local Area Networks—Amendment: Forwarding and Queuing Enhancements for Time-Sensitive Streams”.

Network I/O library 310 is middleware software that provides low level functions to AVB stream handling application. This should be perceived as a proxy between physical hardware (which is in this case network I/O device 110) and upper-layer software applications 160, so that they are able to communicate with registers, memory regions controlled by network I/O device 110, and so on. At the lowest level of software stack 300 is network I/O device driver 140, which operates and/or controls network I/O device 110. Network I/O device driver provides a software interface to network I/O device 110, enabling OS 150 and application 160 to access network I/O hardware functions (such as reading the values of temp sensor 221 and/or dock 219) without needing to know precise details about how the network I/O device operates. In an embodiment, network I/O device driver 140 is resident in kernel space of OS 150. In another embodiment, one or more of timing services 304, stream reservation 306, bandwidth control 308, network I/O library 310, and network I/O device driver are part of OS 150.

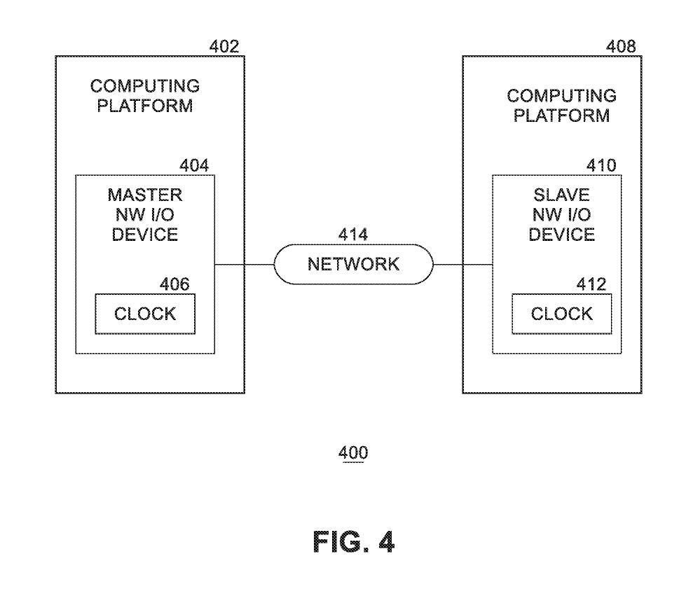

FIG. 4 illustrates an example arrangement 400 of a master clock and a slave clock. A first computing platform 402 includes a master network (NW) I/O device 404 having a master clock 406. First computing platform 402 communicates over network 414 (such as the Internet, for example) with a second computing platform 408. Second computing platform 408 includes a slave NW I/O device 410 having a slave clock 412. Synchronization of master clock 406 and slave clock 412 is necessary in some scenarios for correct processing of applications on computing platforms 402 and 408. When communication between the computing platforms over network 414 fails (e.g., enters a hold-over mode), then the clocks can deviate from synchronization with each other.

In an embodiment, clock sync component 141 within NW I/O device driver 140 in second (e.g., slave) computing platform 408 adjusts slave clock values to overcome hold-over errors. In an embodiment, clock sync component 141 is a part of NW I/O device driver 140 implemented as a Linux software NIC driver. In an embodiment, clock sync 141 requires a PTP connection set up between two separate devices (such as master NW I/O device 404 and slave NW I/O device 410). In one embodiment this is achieved by running an external ptp daemon on Linux OS host 150. Embodiments of the present invention operate in two modes depending on the state of the network 414 connection. In the case of a successful PTP coupling between computing platforms 402, 408 an embodiment creates clock sync DB 143 in second (e.g., slave) computing platform 408 and populates clock sync DB 143 over time with entries indicating what crystal oscillator frequency value is associated with a particular temperature. In this way NW I/O device driver 140 in second computing platform 408 prepares for the situation of losing PTP connectivity.

When the hold-over situation occurs, a selected one of the previously measured and stored frequency values are applied to the local clock source 219 of network I/O device 110 (according to the current temperature) of second computing platform 408 in order to compensate for temperature related hold-over errors. Thus, the two separate network I/O devices (e.g., master 404 and slave 410) in computing platforms 402, 408 should not deviate in terms of clock frequency, because slave clock 412 is being adjusted even though there is no communications connection between the computing platforms.

In normal synchronized operational mode (of the PTP connection) clock sync 141 measures the values of temperature and frequency adjustments. While doing that, clock sync 141 creates a mapping of these two variables (showing the relation between one another) by storing temperature-frequency adjustment information in clock sync DB 143 in second computing system 408. The temperature measurement can be performed with either an externally connected sensor or internal temp sensor 221. In either case, a registry-based application programming interface (API) enables clock sync 141 to read out the current crystal temperature with an acceptable precision level.

In addition to measuring the temperature, clock sync 141 retrieves from network I/O device 110 the frequency adjustment value that is used by local clock 219 (or otherwise indicated by the master clock via synchronization PTP messages). Clock sync 141 stores the frequency adjustment values in clock sync DB 143. In an embodiment, allocation of storage for clock sync DB 143 is performed in an initialization routine of clock sync 141 (invoked upon loading the code as a kernel module). A handle (e.g., a pointer to that memory region) is available in a main structure in OS 150 describing the network I/O device 110 of second computing system 408, so that clock sync 141 can access the information at any time.

As the second computing platform 408 is subjected to normal operational temperature changes in synchronized mode, clock sync 141 periodically collects and stores temperature/frequency adjustment value pairs. In an embodiment, clock sync 141 uses PTP-based methods present in network I/O device drivers 140 supporting PTP. Therefore, the measurements are being done each PTP-system tick. In other embodiments, other protocols may be used.

In hold-over mode (e.g., when the connection between computing platforms is lost), the temperature-frequency adjustment mapping that has been previously measured and stored is used to compensate for clock deviations in slave clock 412. In this scenario, clock sync 141 accesses clock sync DB 143 of stored frequency adjustment-temperature mappings for slave clock 412 and searches for the entry that represents the current temperature level of network I/O device 110 as reported by temp sensor 221, (measured right before accessing clock sync DB 143). In the case of not finding the exact current temperature, clock sync 141 searches for the closest available temperature. In one embodiment, if there is a predetermined high delta between each measured temperature value in clock synchronization DB 143, clock sync 141 does not perform any frequency adjustments. Clock sync 141 applies the adjusted frequency value to slave clock 412 according to the temperature measurement. In an embodiment, this is implemented by modifying an appropriate register (not shown) in network I/O device 110 with the retrieved frequency value.

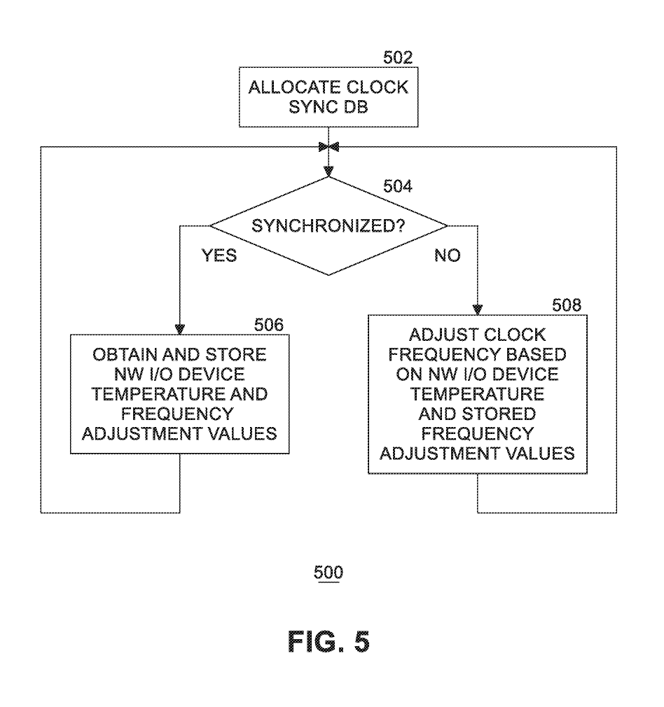

FIG. 5 illustrates an example flow diagram 500 of a process to correct hold over errors according to an embodiment. At block 502 a memory region in primary memory 130 and/or storage devices 165 of second computing platform 408 dedicated for storing the frequency adjustment and temperature measurements is allocated as clock sync DB 143. In an embodiment, clock sync DB 143 allocation is done within the initialization routine of network I/O device driver 140 (called upon loading the device driver as a kernel module inLinux OS 150 of second computing platform 408). In one embodiment, a table is reserved (with an appropriate size to store a significant number of values) using a kmalloc( ) Linux memory allocation routine with a GFP KERNEL parameter. In one embodiment, an adapter data structure that is used to describe network I/O device 110 from the standpoint of NW I/O device driver 140 is enlarged with an additional pointer to clock sync DB 143. This is done so that the temperature/frequency adjustment values in clock sync DB 143 are accessible from components within NW I/O device driver 140 (such as clock sync 141).

After block 502 is performed, NW I/O device driver 140 execution proceeds. NW I/O device driver determines whether there is a synchronized PTP connection state or not at block 504. If the network I/O device is synchronized, then block 506 is performed. In normal synchronized mode, clock sync 141 obtains the current temperature from temp sensor 221 and frequency adjustment value from clock 219. Frequency adjustment value is used to modify clock values from clock 219 to make sure the master clock 406 and slave clock 412 of communicating computing platforms 402, 408 stay in sync. In an embodiment, both temperature and frequency adjustment measurements are performed for every tick of the slave clock 412 in slave NW I/O device driver 410. Clock sync 141 stores the current temperature and associated frequency adjustment value in clock sync DB 143. Clock sync DB 143 is thus populated over time with pairs of local clock frequency adjustment and associated temperature values. This scheme creates a temperature/frequency adjustment correlation, which is able to provide information as to what frequency adjustment should be applied to a local oscillator while operating at a particular temperature in the future. Processing continues with the next synchronization check at block 504.

If the network I/O device is no longer synchronized, then block 508 is performed. In hold-over mode, at block 508 clock sync 141 obtains the current temperature from temp sensor 221, searches clock sync DB 143 for the entry for the current temperature, obtains the frequency adjustment value associated with the current temperature, and adjusts the frequency of local clock 219 based at least in part on the stored frequency adjustment value to avoid deviation. In an embodiment, the frequency alteration is performed by modifying a predetermined location in an increment attributes register in network I/O device 110. Processing continues with the next synchronization check at block 504.

Embodiments of the present invention addresses the hold-over issue in clock sources of PTP devices. This improvement may be used in various computing products, such as in-vehicle infotainment and cockpit systems, wireless base stations, and so on. PTP and synchronization of IEEE1588-based devices are required in time sensitive environments such as in-vehicle infotainment systems. In embodiments, cooperation between AVB devices (using Audio-Video bridging processes) will be still possible, regardless of the potential PTP connection between them.

Embodiments of the present invention can be a beneficial element in any computing platform configuration requiring a clock synchronized connection such as PTP.

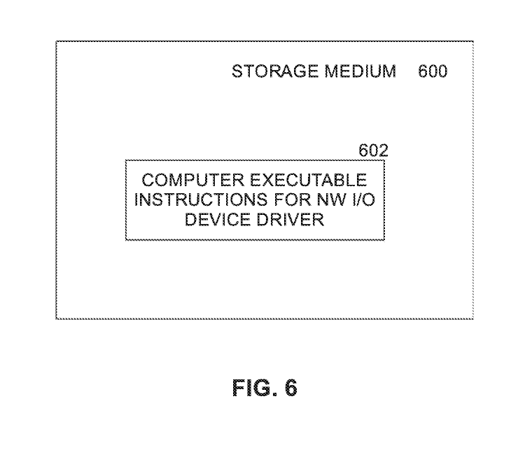

FIG. 6 illustrates an example of a storage medium 600. Storage medium 600 may comprise an article of manufacture. In some examples, storage medium 600 may include any non-transitory computer readable medium or machine readable medium, such as an optical, magnetic or semiconductor storage. Storage medium 600 may store various types of computer executable instructions, such as instructions to implement logic flow 500 of FIG. 5. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

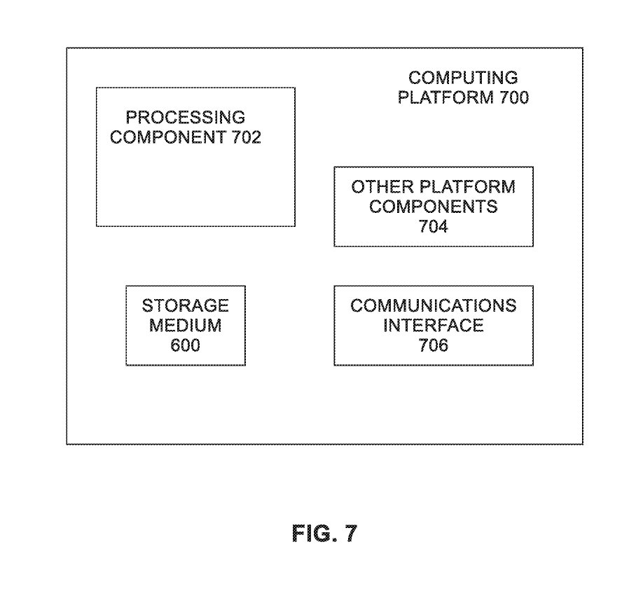

FIG. 7 illustrates an example computing platform 700. In some examples, as shown in FIG. 7, computing platform 700 may include a processing component 702, other platform components 704 and/or a communications interface 706. In an embodiment, computing platform 700 is an infotainment system resident in a vehicle (e.g., an automobile, a truck, a motorcycle, etc.), a ship, an aircraft, or a spacecraft.

According to some examples, processing component 702 may execute processing operations or logic for instructions stored on storage medium 600. Processing component 702 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 704 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), types of non-volatile memory such as 3-D cross-point memory that may be byte or block addressable. Non-volatile types of memory may also include other types of byte or block addressable non-volatile memory such as, but not limited to, multi-threshold level NAND flash memory, NOR flash memory, single or multi-level PCM, resistive memory, nanowire memory, FeTRAM, MRAM that incorporates memristor technology, STT-MRAM, or a combination of any of the above. Other types of computer readable and machine-readable storage media may also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 706 may include logic and/or features to support a communication interface. For these examples, communications interface 706 may include one or more communication interfaces that operate according to various communication protocols or standards to communicate over direct or network communication links or channels. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Switch Specification.

The components and features of computing platform 700, including logic represented by the instructions stored on storage medium 600 may be implemented using any combination of discrete circuitry, ASICs, logic gates and/or single chip architectures. Further, the features of computing platform 700 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 700 shown in the block diagram of FIG. 7 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASIC, programmable logic devices (PLD), digital signal processors (DSP), FPGA, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Included herein are logic flows or schemes representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow or scheme may be implemented in software, firmware, and/or hardware. In software and firmware embodiments, a logic flow or scheme may be implemented by computer executable instructions stored on at least one non-transitory computer readable medium or machine readable medium, such as an optical, magnetic or semiconductor storage. The embodiments are not limited in this context.

Some examples are described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
determining, at a first computing platform, whether a first computing platform has a synchronized connection with a second computing platform over a network;
when the first computing platform has a synchronized connection with the second computing platform, obtaining a first temperature of a network input/output (I/O) device of the first computing platform and a frequency adjustment value of a clock of the network I/O device, and storing the temperature and the frequency adjustment value in an entry in a clock synchronization database;
when the first computing platform does not have a synchronized connection with the second computing platform, obtaining a second temperature of the network I/O device, searching the clock synchronization database for the entry where the first temperature is closest to the second temperature, and when the entry is found, obtaining the frequency adjustment value and adjusting the clock of the network I/O device using the frequency adjustment value.

2. The method of claim 1, wherein the clock is a slave clock synchronized with a master clock of the second computing platform.

3. The method of claim 2, wherein the slave clock and the master clocks are synchronized using a Precision Time Protocol (PTP).

4. The method of claim 1, comprising performing obtaining the first temperature of the network I/O device of the first computing platform and the frequency adjustment value of the clock of the network I/O device, and storing the temperature and the frequency adjustment value in the entry in the clock synchronization database for every tick of the clock.

5. The method of claim 1, comprising allocating the clock synchronization database in a memory of the second computing platform during initialization of a driver for the network I/O device.

6. The method of claim 1, comprising omitting adjusting the clock of the network I/O device using the frequency adjustment value when the difference between the first temperature and the second temperature is greater than a predetermined value.

7. At least one tangible machine-readable medium comprising a plurality of instructions that in response to being executed by a processing system cause the processing system to:
determine, at a first computing platform, whether a first computing platform has a synchronized connection with a second computing platform over a network;
when the first computing platform has a synchronized connection with the second computing platform, obtain a first temperature of a network input/output (I/O) device of the first computing platform and a frequency adjustment value of a clock of the network I/O device, and store the temperature and the frequency adjustment value in an entry in a clock synchronization database;
when the first computing platform does not have a synchronized connection with the second computing platform, obtain a second temperature of the network I/O device, search the clock synchronization database for the entry where the first temperature is closest to the second temperature, and when the entry is found, obtain the frequency adjustment value and adjust the clock of the network I/O device using the frequency adjustment value.

8. The at least one tangible machine-readable medium of claim 7, wherein the clock is a slave clock synchronized with a master clock of the second computing platform.

9. The at least one tangible machine-readable medium of claim 8, wherein the slave clock and the master clocks are synchronized using a Precision Time Protocol (PTP).

10. The at least one tangible machine-readable medium of claim 7, comprising instructions to perform obtaining the first temperature of the network I/O device of the first computing platform and the frequency adjustment value of the clock of the network I/O device, and storing the temperature and the frequency adjustment value in the entry in the clock synchronization database for every tick of the clock.

11. The at least one tangible machine-readable medium of claim 7, comprising instructions to allocate the clock synchronization database in a memory of the second computing platform during initialization of a driver for the network I/O device.

12. The At least one tangible machine-readable medium of claim 7, comprising instructions to omit adjusting the clock of the network I/O device using the frequency adjustment value when the difference between the first temperature and the second temperature is greater than a predetermined value.

13. A system comprising:
a network input/output (I/O) device including a clock;
one or more processors; and
a non-transitory machine-readable storage medium having instructions stored therein,
which when executed by the one or more processors, causes the system to:
determine whether the network I/O device has a synchronized connection with a second network I/O device of a second computing platform over a network;
when the network I/O device has a synchronized connection with the second network I/O device of the second computing platform, obtain a first temperature of the network I/O device and a frequency adjustment value of the clock of the network I/O device, and store the temperature and the frequency adjustment value in an entry in a clock synchronization database;
when the network I/O device does not have a synchronized connection with the second network I/O device of the second computing platform, obtain a second temperature of the network I/O device, search the clock synchronization database for the entry where the first temperature is closest to the second temperature, and when the entry is found, obtain the frequency adjustment value and adjust the clock of the network I/O device using the frequency adjustment value.

14. The system of claim 13, wherein the clock is a slave clock synchronized with a master clock of the second computing platform.

15. The system of claim 14, wherein the slave clock and the master clocks are synchronized using a Precision Time Protocol (PTP).

16. The system of claim 13, the non-transitory machine-readable storage medium comprising instructions to perform obtaining the first temperature of the network I/O device and the frequency adjustment value of the clock of the network I/O device and storing the temperature and the frequency adjustment value in the entry in the clock synchronization database for every tick of the clock.

17. The system of claim 13, the system including a memory and the non-transitory machine-readable storage medium comprising instructions to allocate the clock synchronization database in the memory of the system during initialization of a driver for the network I/O device.

18. The system of claim 13, the non-transitory machine-readable storage medium comprising instructions to omit adjusting the clock of the network I/O device using the frequency adjustment value when the difference between the first temperature and the second temperature is greater than a predetermined value.
